(19) United States
(12) Patent Application Publication
(10) Pub. No.: US 2016/0078829 A1
(43) Pub. Date: Mar. 17, 2016

(54) Driving Device and Display System thereof

(71) Applicant: NOVATEK Microelectronics Corp., Hsin-Chu (TW)

(72) Inventors: Teng-Jui Yu, Taoyuan County (TW); Shun-Hsun Yang, Hsinchu City (TW); Hsiang-Ning Liu, Taoyuan County (TW); Li-Tang Lin, Hsinchu City (TW)

(21) Appl. No.: 14/484,238

(22) Filed: Sep. 11, 2014

(51) Int. Cl. G09G 3/36

(52) U.S. Cl. CPC G09G 3/3611; G09G 2310/0232; G09G 2340/0464; G09G 2330/021; G09G 2340/0442

(57) ABSTRACT

A driving device for a display system, comprising a first signal line, connecting to a timing control device of the display system for transmitting an instruction signal; a second signal line, connecting to the timing control device for transmitting a sync clock signal; and a plurality of driving units, for receiving the instruction signal from a timing control device of the display system via the first signal line, receiving a sync clock signal from the timing control device via the second signal line and generating a plurality of driving signals to a display device of the display system according to the instruction signal and the sync clock signal.

### BACKGROUND OF THE INVENTION

1. Field of the Invention

The present invention relates to a driving device and display system thereof, and more particularly, to a driving device with a new serial bus structure and display system thereof.

2. Description of the Prior Art

A liquid crystal display (LCD) is a flat panel display which has the advantages of low radiation, light weight and low power consumption and is widely used in various information technology (IT) products, such as notebook computers, personal digital assistants (PDA), and mobile phones. An active matrix thin film transistor (TFT) LCD is the most commonly used transistor type in LCD families, especially in the large-size LCD family. A driving system installed in the LCD, includes a timing controller, source drivers and gate drivers. The source and gate drivers respectively control data lines and scan lines, which intersect to form a cell matrix. Each intersection is a cell including crystal display molecules and a TFT.

As technology advanced, the functions of the gate drivers and source drivers become diverse and the numbers of the signal lines in the serial buses of the gate drivers and source drivers significantly increase. However, the number of the signal lines cannot increase unlimitedly due to limited layout area on the circuit board (e.g. a glass substrate) of the LCD. Thus, how to reduce the number of the signal lines becomes a topic to be discussed.

### SUMMARY OF THE INVENTION

In order to solve the above problem, the present invention provides a driving device with a new serial bus structure and display system thereof.

The present invention discloses a driving device for a display system, comprising a first signal line, connecting to a timing control device of the display system for transmitting an instruction signal; a second signal line, connecting to the timing control device for transmitting a sync clock signal; and a plurality of driving units, for receiving the instruction signal from a timing control device of the display system via the first signal line, receiving a sync clock signal from the timing control device via the second signal line and generating a plurality of driving signals to a display device of the display system according to the instruction signal and the sync clock signal.

The present invention further discloses a display system, comprising a display device; a timing control device, for generating an instruction signal and a sync clock signal; and a driving device, comprising a first signal line, connecting to the timing control device for transmitting the instruction signal; a second signal line, connecting to the timing control device for transmitting the sync clock signal; and a plurality of driving units, for receiving the instruction signal from a timing control device of the display system via the first signal line, receiving a sync clock signal from the timing control device via the second signal line and generating a plurality of driving signals to a display device of the display system according to the instruction signal and the sync clock signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of an exemplary embodiment of the display system shown in FIG. 1.

FIG. 3 is a schematic diagram of a display system according to an embodiment of the present invention.

FIG. 4 is a schematic diagram of a display system according to an embodiment of the present invention.

FIG. 5 is a schematic diagram of a display system according to an embodiment of the present invention.

FIG. 6 is a schematic diagram of a display system according to an embodiment of the present invention.

FIG. 7 is a schematic diagram of a display system according to an embodiment of the present invention.

FIGS. 8A-8D are schematic diagrams of display systems according to embodiments of the present invention.

FIGS. 9A-9D are schematic diagrams of display systems according to embodiments of the present invention.

### DETAILED DESCRIPTION

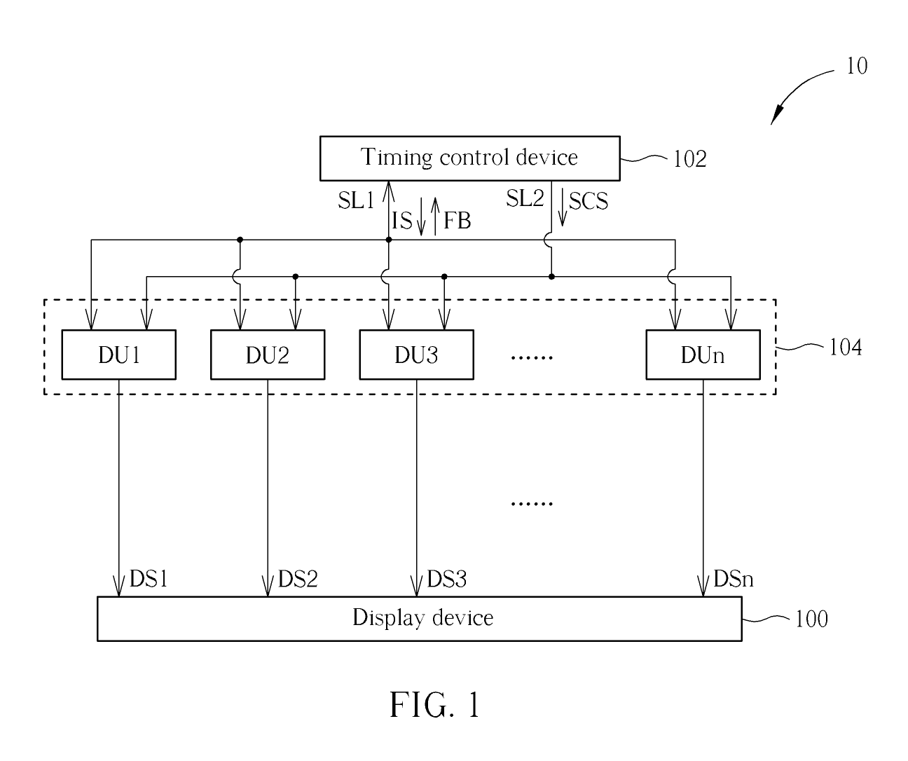

Please refer to FIG. 1, which is a schematic diagram of a display system 10 according to an embodiment of the present invention. The display system 10 may be a liquid crystal display, and is not limited herein. As shown in FIG. 1, the display system 10 comprises a display device 100, a timing control device 102 and a driving device 104. The display device 100 may be a panel and comprises a plurality of display components (not shown in FIG. 1), such as crystal molecules, pixels, data lines, and scan lines. The timing control device 102 is utilized for generating an instruction signal IS and a sync clock signal SCS. For example, the timing control device 102 may be a timing controller, and is not limited herein. The driving device 104 comprises signal lines SL1, SL2 and a plurality of driving units DU1-DUn. The signal lines SL1 and SL2 are coupled between the timing control device 102 and each of the driving units DU1-DUn, for transmitting the instruction signal IS and the sync clock signal SCS to the driving units DU1-DUn, respectively. The driving units DU1-DUn is utilized for generating driving signals DS1-DSn of the plurality of display components in the display device 100. For example, the driving device 104 may be a source driver for driving data lines of the display device 100 or a gate driver for driving scan lines of the display device 100. In such a condition, the driving units DU1-DUn generate the driving signals DS1-DSn according to the instruction signal IS and the sync clock signal. That is, there are at most two signal lines between the timing control device 102 and the driving device 104. The number of signal lines between the timing control device 102 and the driving device 104 can be reduced, the design complexity of the layout of the display system 10 is simplified, and the manufacturing cost of the display system 10 is decreased, therefore.

In detail, the timing control device 102 controls the driving units DU1-DUn to perform specific operations via the instruction signal IS and synchronizes the clock signals of the driving units DU1-DUn via the sync clock signal SCS. After the clock signal of the driving units DU1-DUn is synchronized according to the sync clock signal SCS, each of the driving units DU1-DUn determines the operations instructed by the instruction signal IS according to the synchronized clock signal and performs the operations as instructed by the timing control device 102. For example, the instruction signal IS may comprise commands for the driving units DU1-DUn, the driving units DU1-DUn decode the instruction signal IS to acquire the commands and perform the operations according to the commands. Therefore, the timing control device 102 can use only two signal lines (i.e. signal lines SL1 and SL2) to control the driving device 104.

In an embodiment, the timing control device 102 is required to control the driving unit DU1 to switch the driving signal DS1. In such a condition, the timing control device 102 generates the instruction signal IS with a command for instructing the driving unit DU1 to switch the driving signal DS1. After the clock signals of the driving units DU1-DUn are synchronized according to the sync clock signal SCS, the driving unit DU1 decodes the instruction signal IS, acquires the command, and switches the driving signal DS1 according to the command (i.e. according to the instruction signal IS). On the other hand, the driving units DU2-DUn decode the instruction signal IS, acquire the command, and stay idle according to the instruction signal IS.

In another embodiment, the timing control device 102 is required to control the driving units DU1-DUn to adjust the driving signals DS1-DSn to voltages V1-Vn, respectively. The timing control device 102 generates the instruction signal IS with commands of adjusting the driving signals DS1-DSn to the voltages V1-Vn. After the clock signals of the driving units DU1-DUn are synchronized according to the sync clock signal SCS, the driving units DU1-DUn decode the instruction signal, acquire the commands, and adjust the driving signals DS1-DSn to the voltages V1-Vn, respectively, according to the instruction signal IS.

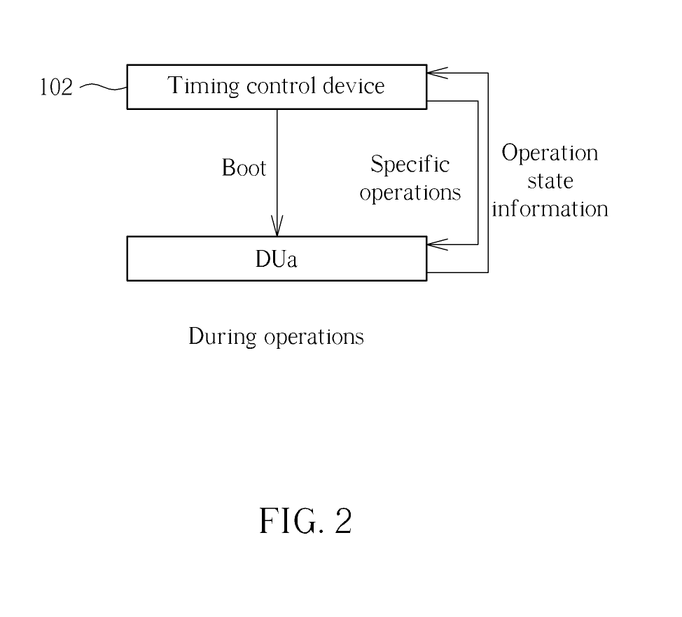

Furthermore, the timing control device 102 may require the driving units DU1-DUn to feedback operation state information, such as system statistics and error state information, for optimizing the operations of the driving device 104. For example, please refer to FIG. 2 which is a schematic diagram of an exemplary embodiment of the display system 10. After the display system 10 boots up and the timing control device 102 transmits the instruction signal IS and the sync clock signal SCS, the timing control device 102 can further exchange messages (e.g. the system statistics or the error state information) with a driving unit DUa, which can be any one of the driving units DU1-DUn, during the operations of the display system 10. The timing control device 102 may perform specific operations according to the feedback message from the driving unit DUa. In an embodiment, the driving unit DUa transmits the error state information to the timing control device 102 during the operations of the display system 10, to indicate that the operations of the driving unit Dua work abnormally. In such a condition, the timing control device 102 reset the driving unit DUa according to the error state information from the driving unit DUa. In another embodiment, the driving unit DUa transmits the system statistics to the timing control device 102 and the timing control device 102 can optimize the system parameters of the driving unit DUa according to the system statistics from the driving unit DUa during the operations of the display system 10.

Specifically speaking, Please back to FIG. 1, the timing control device 102 may generate the instruction signal IS with a command of instructing one of the driving units DU1-DUn to feedback the operation state information during the operations of the display system 10. According to the instruction signal IS and the sync clock signal SCS, the driving unit being instructed determines to generate a feedback signal FB comprising the operation state information and transmit the feedback signal FB to the timing control device 102 via the signal line SL1. According to the feedback signal FB, the timing control device 102 can adjust the instruction signal IS and the sync clock signal SCS to optimize the operations of the driving device 104.

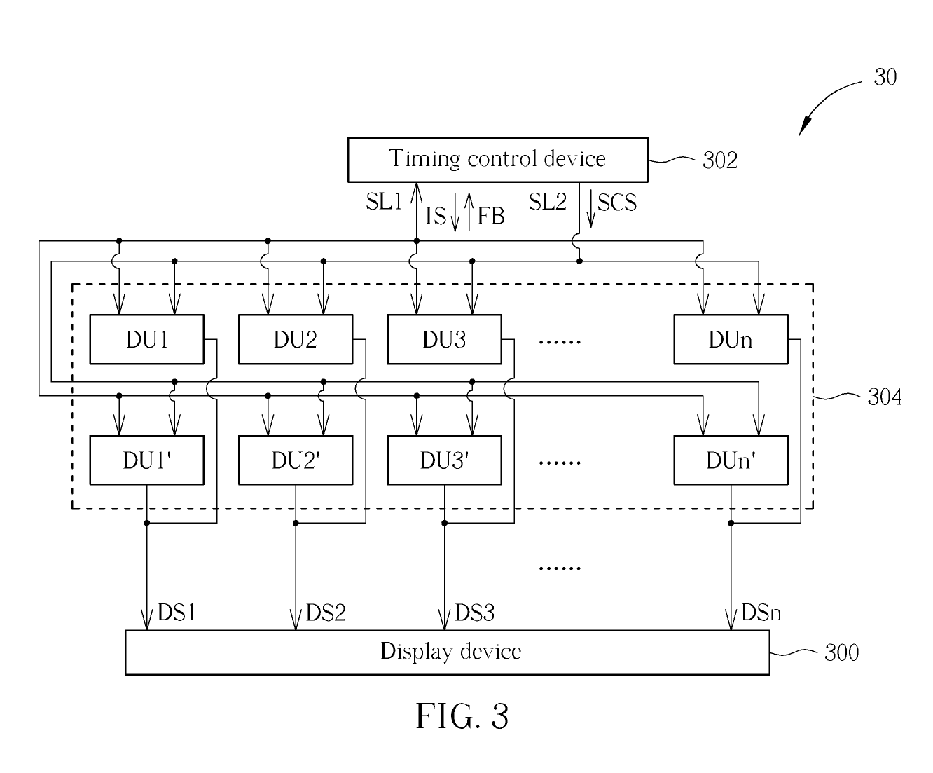

Please refer to FIG. 3, which is a schematic diagram of a display system 30 according to an embodiment of the present invention. The display system 30 may be a liquid crystal display, and is not limited herein. The display system 30 is similar to the display system 10 shown in FIG. 1; thus, the signals and the components with the similar functions use the same symbols. Different from the display system 10 shown in FIG. 1, the display system 30 is realized in dual side driving structure and further comprises driving units DU1′-DUn′. The driving units DU1-DUn are respectively corresponding to the driving units DU1′-DUn′ (e.g. the driving units DU1 is corresponding to the driving units DU1′, the driving units DU2 is corresponding to the driving units DU2, and so on), and the driving units DU1-DUn and DU1′-DUn′ are configured at different opposite sides of the display device 300 for generating the driving signal of the same display component (e.g. the driving units DU1 and DU1′ generate the driving signal DS1, the driving units DU2 and DU2′ generate the driving signal DS2, and so on). In this embodiment, the signal lines SL1 and SL2 are coupled between the timing control device 302 and each of the driving units DU1-DUn and DU1′-DUn′, for transmitting the instruction signal IS and the sync clock signal SCS to the driving units DU1-DUn and DU1′-DUn′. Thus, the driving units DU1-DUn and DU1′-DUn′ can generate the driving signals DS1-DSn according to the instruction signal IS and the sync clock signal. The number of signal lines between the timing control device 302 and the driving device 304 can be reduced, the design complexity of the layout of the display system 30 is simplified, and the manufacturing cost of the display system 30 is decreased, therefore. The detailed operations of the display system 30 can be referred to the above, and are not narrated herein for brevity.

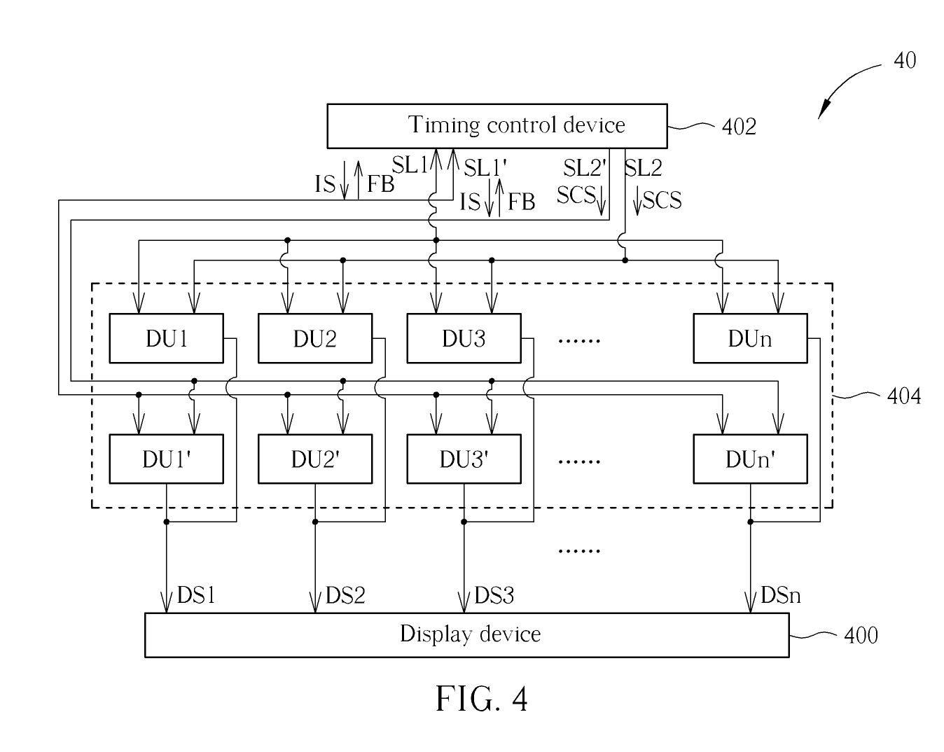

Please refer to FIG. 4, which is a schematic diagram of a display system 40 according to an embodiment of the present invention. The display system 40 may be a liquid crystal display, and is not limited herein. The display system 40 is similar to the display system 30 shown in FIG. 3; thus, the signals and the components with the similar functions use the same symbols. Since the driving units DU1-DUn and DU1′-DUn′ are configured at different side of the display device 400, the timing control device 402 is coupled to the driving units DU1-DUn via the signal lines SL1 and SL2 and is coupled to the driving units DU1′-DUn′ via signal lines SL1′ and SL2′ in order to simplify the layout complexity of the display system 40. The detailed operations of the display system 40 can be referred to the above, and are not described herein for brevity.

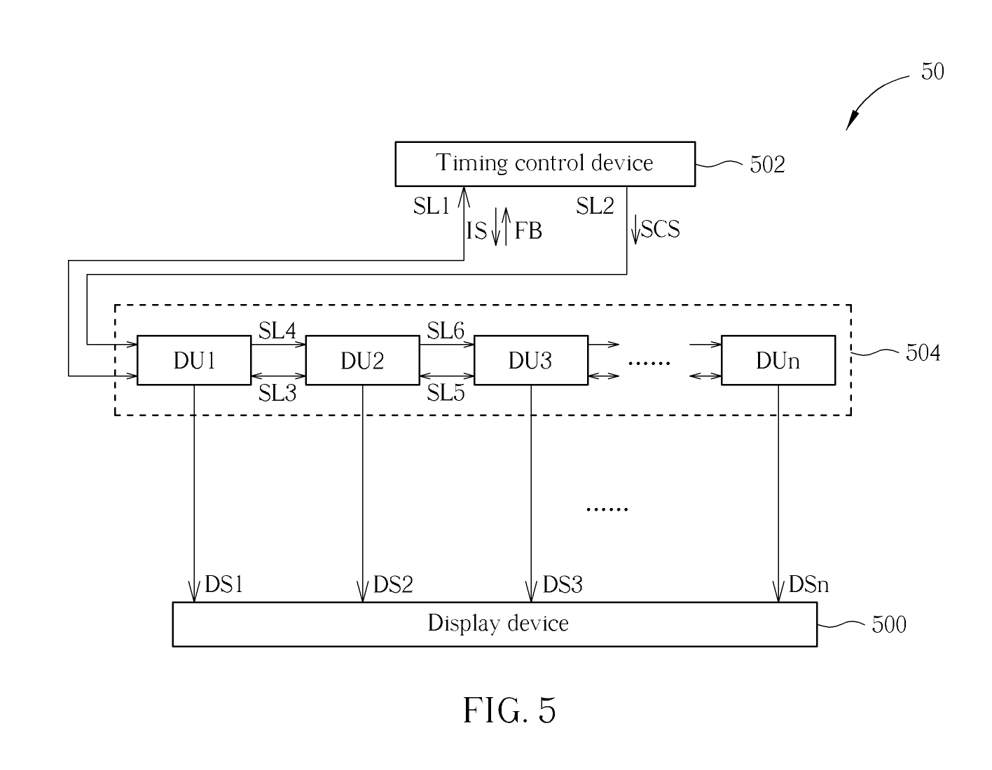

Please refer to FIG. 5, which is a schematic diagram of a display system 50 according to an embodiment of the present invention. The display system 50 may be a liquid crystal display, and is not limited herein. The display system 50 is similar to the display system 10 shown in FIG. 1; thus, the signals and the components with the similar functions use the same symbols. In this embodiment, the signal lines SL1 and SL2 are between the timing control device 502 and the driving unit DU1. In order to transmit the instruction signal IS and the sync clock signal SCS to the driving units DU2-DUn, the driving unit DU1 is coupled to the driving unit DU2 via signal lines SL3 and SL4, the driving unit DU2 is coupled to the driving unit DU3 via signal lines SL5 and SL6, and so on. In such a condition, the driving units DU1-DUn generate the driving signals DS1-DSn according to the instruction signal IS and the sync clock signal SCS. The number of signal lines between the timing control device 502 and the driving device 504 can be reduced, the design complexity of the layout of the display system 50 can be simplified, and the manufacturing cost of the display system 50 can be decreased, therefore. The detailed operations of the display system 50 can be referred to the above, and are not narrated herein for brevity.

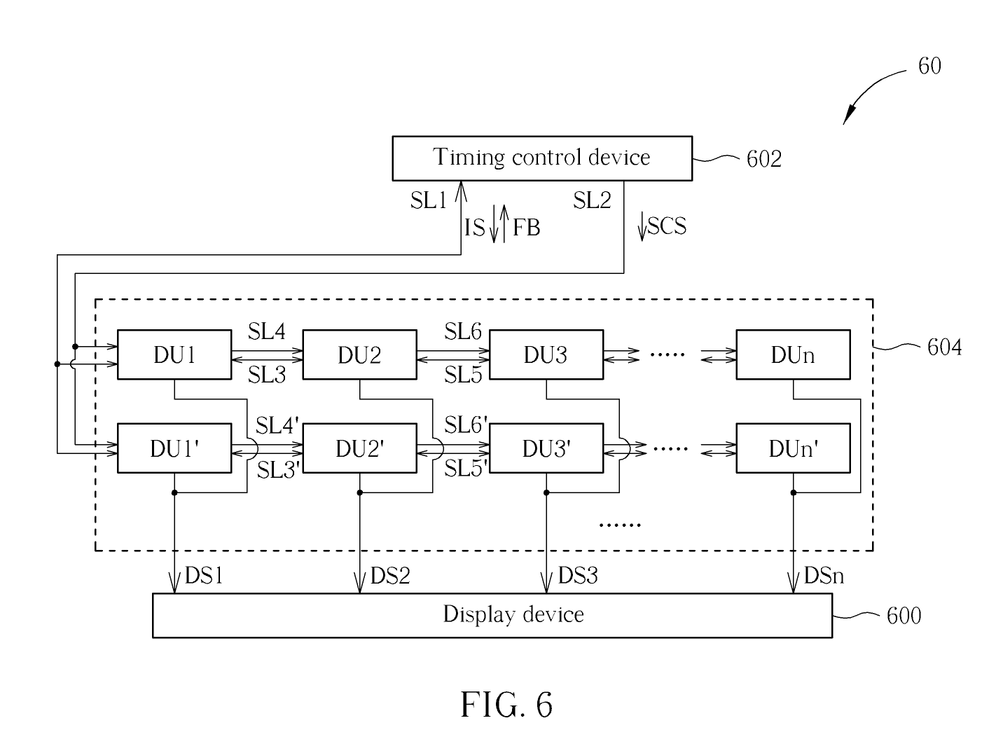

Please refer to FIG. 6, which is a schematic diagram of a display system 60 according to an embodiment of the present invention. The display system 60 may be a liquid crystal display, and is not limited herein. The display system 60 is similar to the display system 50 shown in FIG. 5; thus, the signals and the components with the similar functions use the same symbols. In comparison with the display system 50, the display system 60 further comprises driving units DU1′-DUn′. The driving units DU1-DUn are respectively corresponding to the driving units DU1′-DUn′ (e.g. the driving units DU1 is corresponding to the driving units DU1′, the driving units DU2 is corresponding to the driving units DU2, and so on), and the driving units DU1-DUn and DU1′-DUn′ are configured at different opposite sides of the display device 600 for generating the driving signal of the same display component (e.g. the driving units DU1 and DU1′ generate the driving signal DS1). In this embodiment, the driving unit DU1′ is also coupled to the signal lines SL1 and SL2, the driving unit DU1′ is coupled to the driving unit DU2′ via signal lines SL3′ and SL4′, the driving unit DU2′ is coupled to the driving unit DU3′ via signal lines SL5′ and SL6′, and so on. In such a condition, all of the driving units DU1-DUn and DU1′-DUn′ receive the instruction signal IS and sync clock signal SCS and generate the driving signals DS1-DSn according to the instruction signal IS and sync clock signal SCS. The number of signal lines between the timing control device 602 and the driving device 604 can be reduced, the design complexity of the layout of the display system 60 can be simplified, and the manufacturing cost of the display system 60 can be decreased, therefore. The detailed operations of the display system 60 can be referred to the above, and are not described herein for brevity.

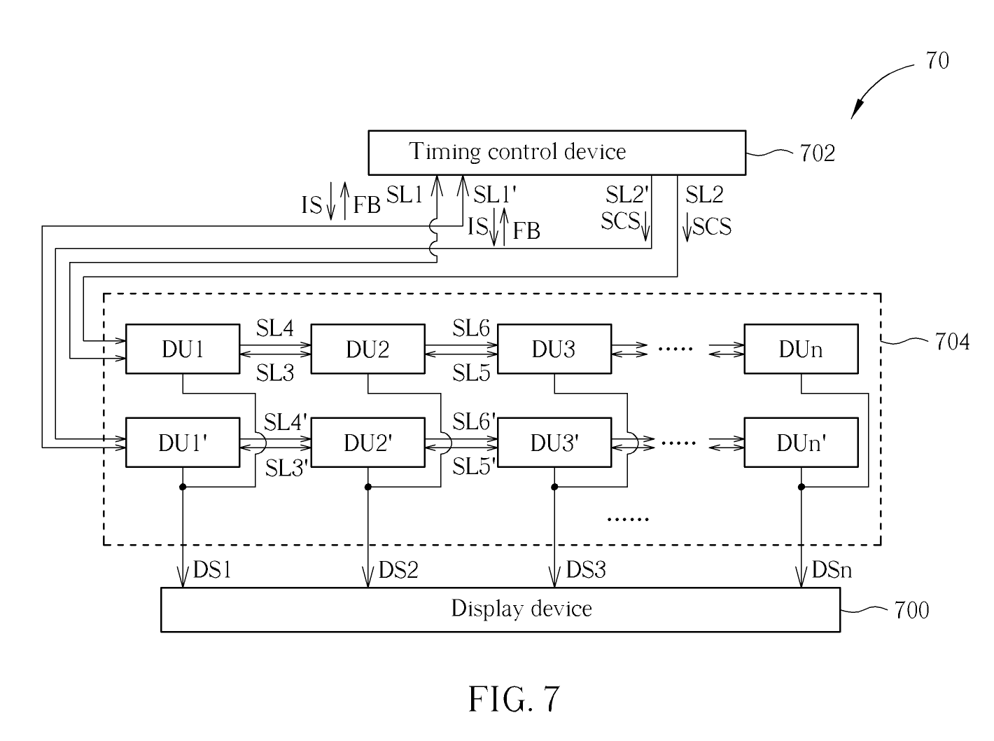

Please refer to FIG. 7, which is a schematic diagram of a display system 70 according to an embodiment of the present invention. The display system 60 may be a liquid crystal display, and is not limited herein. The display system 70 is similar to the display system 60 shown in FIG. 6; thus, the signals and the components with the similar functions use the same symbols. Since the driving units DU1-DUn and DU1′-DUn′ are configured at different sides of the display device 700, the timing control device 702 is coupled to the driving unit DU1 via the signal lines SL1 and SL2 and is coupled to the driving unit DU1 via signal lines SL1′ and SL2′ in order to simplify the layout complexity of the display system 70. The detailed operations of the display system 70 can be referred to the above, and are not discussed herein for brevity.

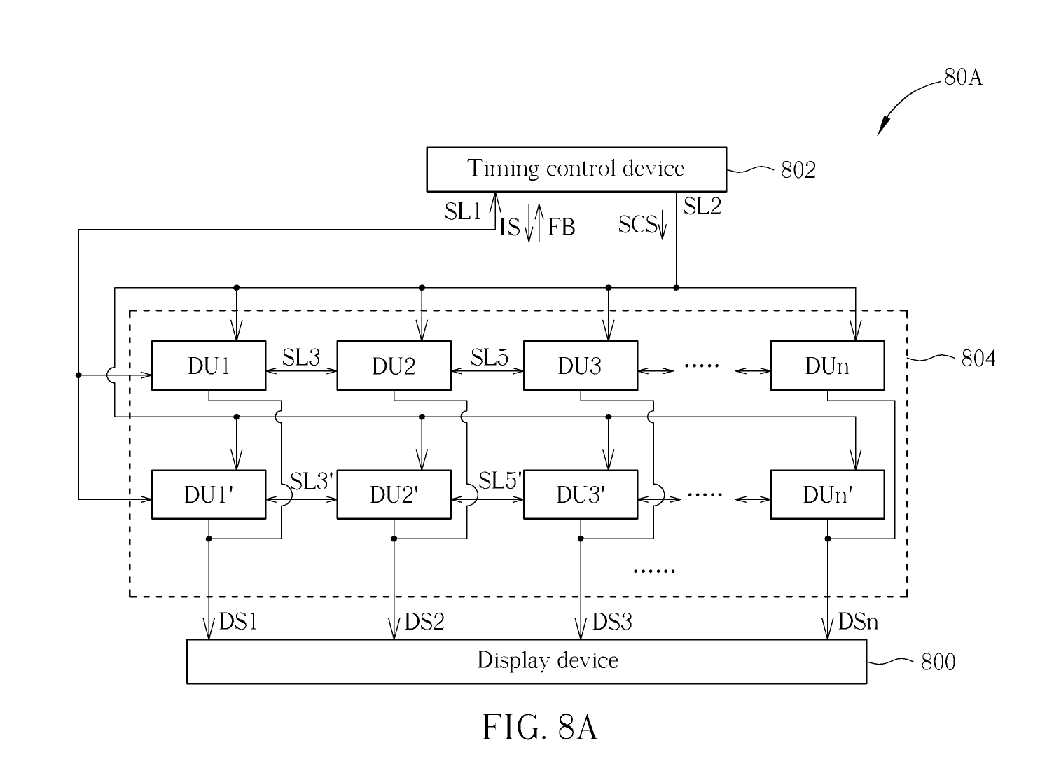

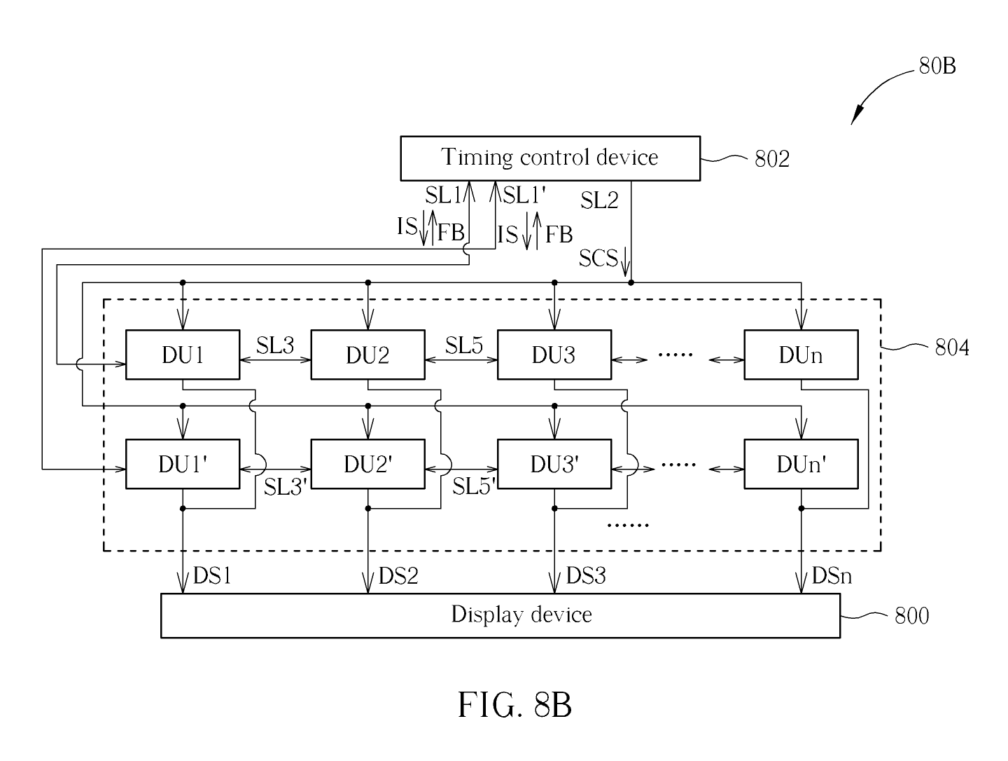

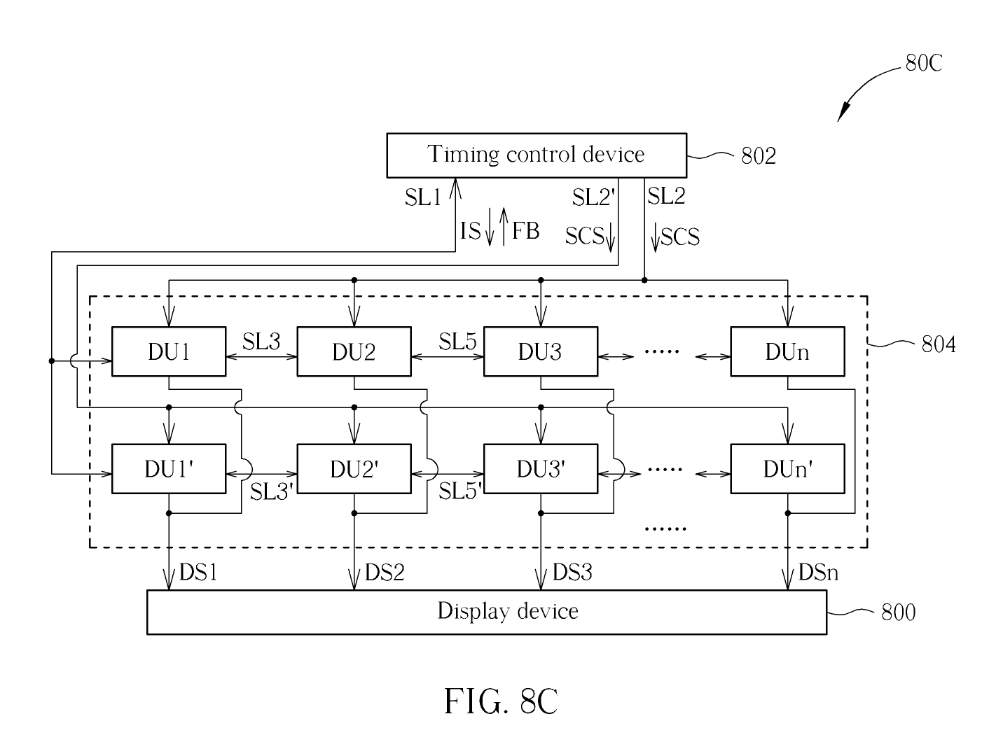

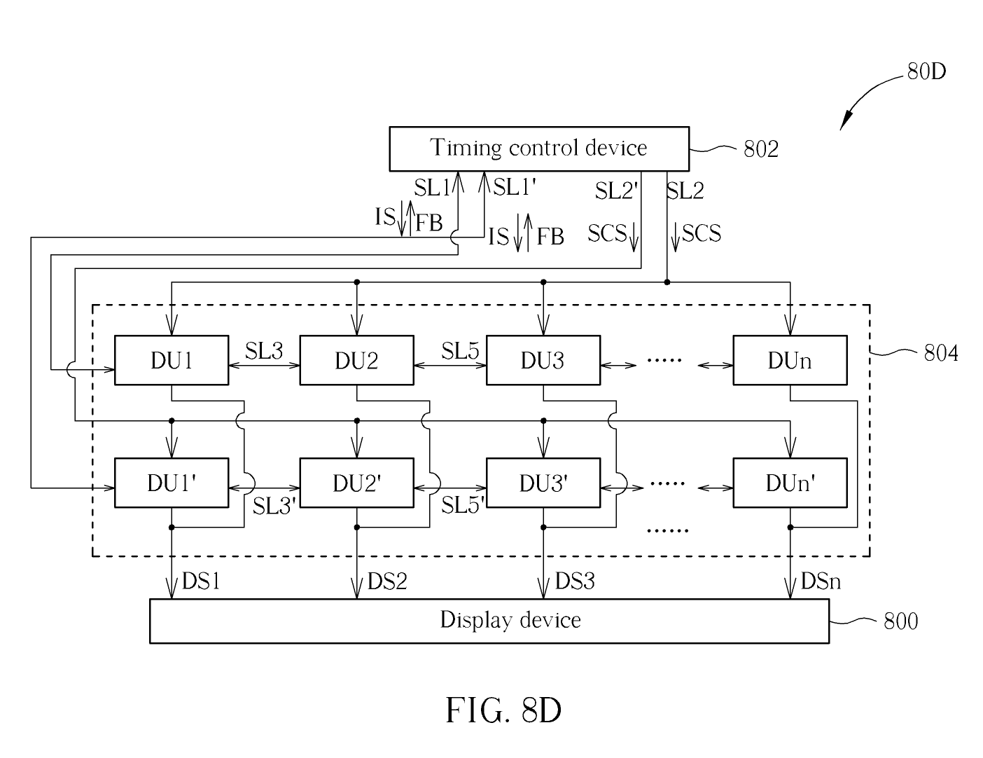

In an embodiment, the instruction signal IS and the sync clock signal SCS may be transmitted to the driving units DU1-DUn and DU1′-DUn′ via different structures. Please refer to FIGS. 8A-8D, which are schematic diagrams of display systems 80A-80D according to embodiments of the present invention. The display systems 80A-80D are similar to the display system 60 shown in FIG. 6; thus, the signals and the components with the similar functions use the same symbols. As shown in FIG. 8A, the instruction signal IS is transmitted to the driving units DU1-DUn and DU1′-DUn′ via a parallel structure as shown in FIG. 6 and the sync clock signal is transmitted to the driving units DU1-DUn and DU1′-DUn′ via a multi-drop structure as shown in FIG. 3. Similarly, in FIG. 8B, the instruction signal IS is transmitted to the driving units DU1-DUn and DU1′-DUn′ via a parallel structure as shown in FIG. 7 and the sync clock signal is transmitted to the driving units DU1-DUn and DU1′-DUn′ via the multi-drop structure as shown in FIG. 3. In FIG. 8C, the instruction signal IS is transmitted to the driving units DU1-DUn and DU1′-DUn′ via the parallel structure as shown in FIG. 6 and the sync clock signal is transmitted to the driving units DU1-DUn and DU1′-DUn′ via a multi-drop structure as shown in FIG. 4. In FIG. 8D, the instruction signal IS is transmitted to the driving units DU1-DUn and DU1′-DUn′ via the parallel structure as shown in FIG. 7 and the sync clock signal is transmitted to the driving units DU1-DUn and DU1′-DUn′ via the multi-drop structure as shown in FIG. 4. The method of connecting the timing control device and the driving device can be modified according to different applications and design concepts, and is not limited herein.

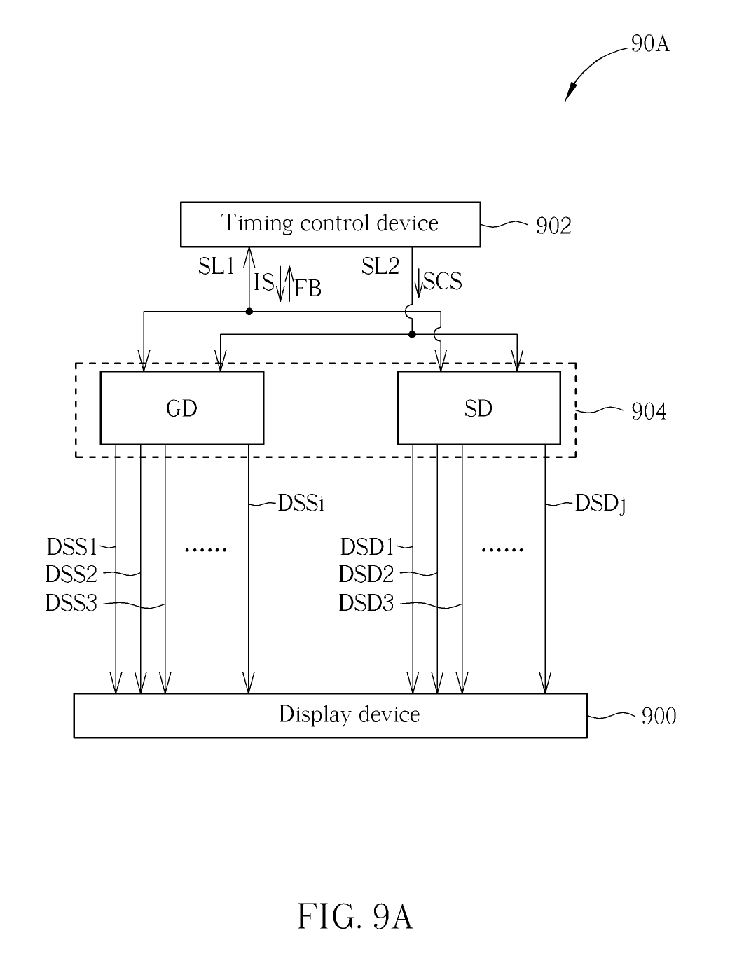

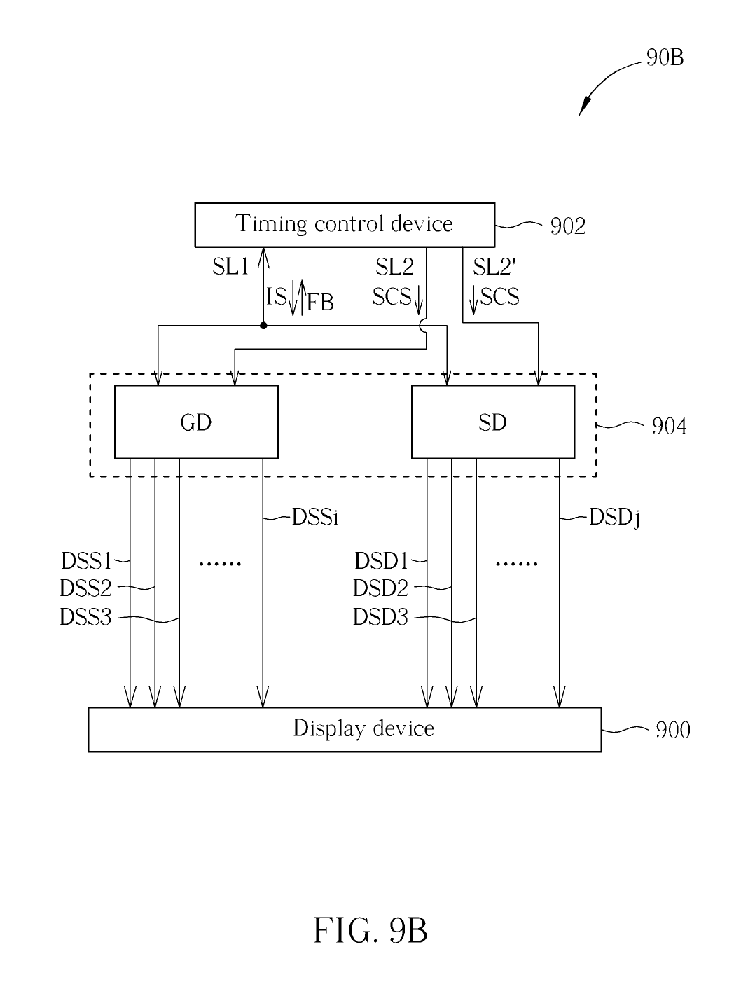

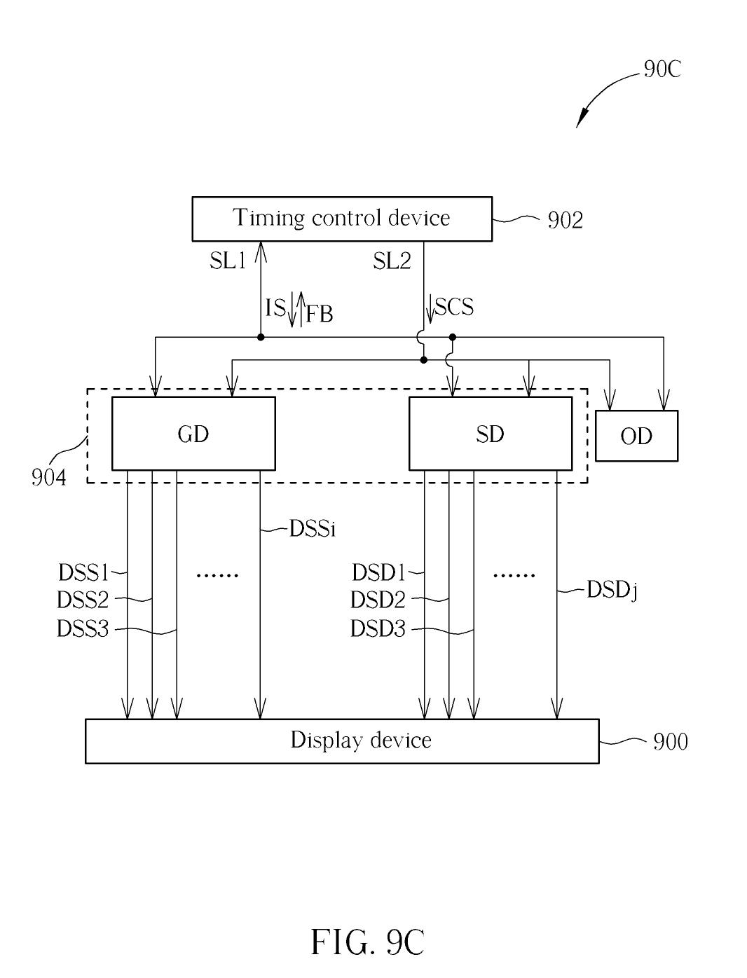

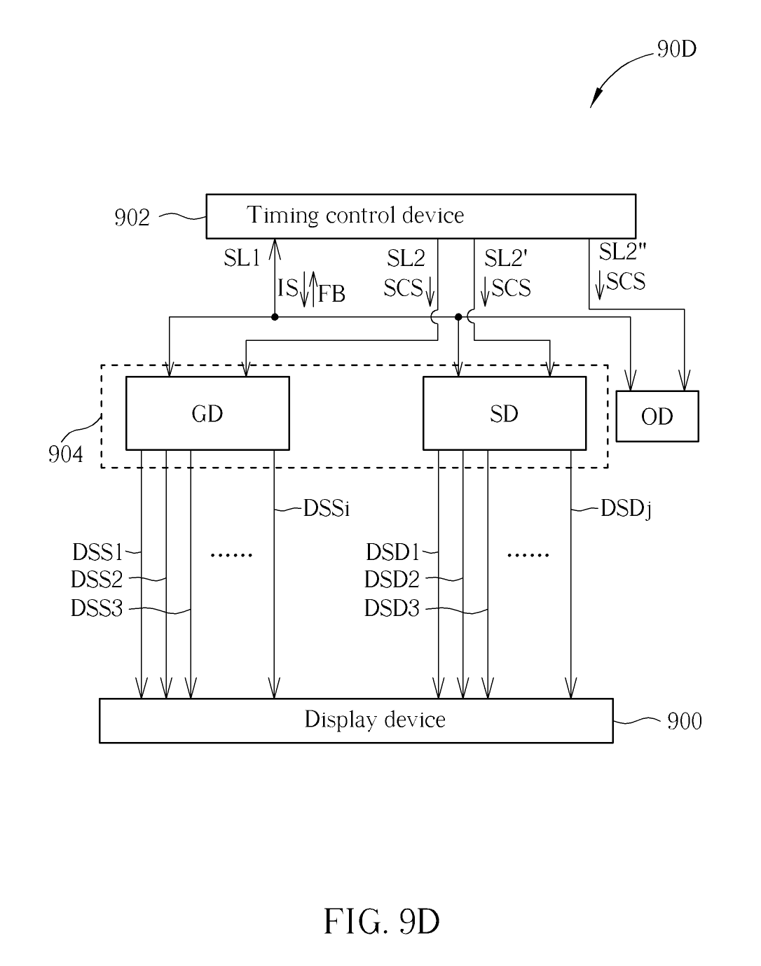

Furthermore, the driving device may comprise driving units utilized for generating driving signals of different types of display components. Please refer to FIGS. 9A-9D, which are schematic diagrams of display systems 90A-90D according to embodiments of the present invention. The display systems 90A-90D are similar to the display system 10 shown in FIG. 1; thus, the signals and the components with the similar functions use the same symbols. In FIG. 9A, the driving device 904 comprises a gate driving module GD for generating driving signals DSS1-DSSi of scan lines of the display device 900 and a source driving module SD for generating driving signals DSD1-DSDj of data lines of the display device 900. For example, the gate driving module GD may comprise a plurality of driving units (e.g. the driving units DU1-DUn shown in FIG. 1) for generating the driving signals DSS1-DSSi). Similarly, the source driving module SD may comprise a plurality of driving units (e.g. the driving units DU1-DUn shown in FIG. 1) for generating the driving signals DSD1-DSDi). The gate driving module GD and the source driving module SD jointly use the signal line SL1 to receive the instruction signal IS from the timing control device 902 and to feedback the operation state information to the timing control device 902, and use the signal line SL2 to receive the sync clock signal SCS. According to different applications and design concepts, the connection method among the driving units of the gate driving module GD and the source driving module SD can be accordingly changed. For example, the connection method among the driving units of the gate driving module GD and the source driving module SD may be the multi-drop structure as shown in FIG. 1 or the parallel structure as shown in FIG. 5.

In the embodiment shown in FIG. 9B, the gate driving module GD and the source driving module SD jointly use the signal line SL1 to receive the instruction signal IS from the timing control device 902 and to feedback the operation state information to the timing control device 902 via the feedback signal FB. Different from FIG. 9A, driving module GD and the source driving module SD use different signal lines SL2 and SL2′ to respectively receive the sync clock signal SCS.

In the embodiment shown in FIG. 9C, the display system 90 further comprises driving device OD. The driving device OD may be a gamma integrated circuit utilized for generating a gamma curve or a power integrated circuit utilized for generating powers of other circuits (e.g. gate driving module GD and the source driving module SD) in the display system 90C. As shown in FIG. 9C, the gate driving module GD, the source driving module SD and the driving device OD jointly use the signal lines SL1 and SL2 to receive the instruction signal IS and sync clock signal SCS from the timing control device 902, and to feedback the operation state information to the timing control device 902 via the feedback signal FB.

In the embodiment shown in FIG. 9D, the gate driving module GD, the source driving module SD and the driving device OD jointly use the signal lines SL1 to receive the instruction signal IS from the timing control device 902, and to feedback the operation state information to the timing control device 902 via the feedback signal FB. Different from FIG. 9C, driving module GD, the source driving module SD and the driving device OD use different signal lines SL2, SL2′ and SL2″ to respectively receive the sync clock signal SCS.

To sum up, the display systems of the above embodiments control the driving units utilized for generating the driving signals of the display components in the display device and/or other circuits in the display system via at most two signal lines. The number of the signal lines between the timing control device and the driving device and/or other circuits in the display system is therefore reduced, such that the layout complexity of the display system can be simplified and the manufacturing cost of the display system can be decreased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving device for a display system, comprising:
a first signal line, connecting to a timing control device of the display system for transmitting an instruction signal;
a second signal line, connecting to the timing control device for transmitting a sync clock signal; and
a plurality of driving units, for receiving the instruction signal from a timing control device of the display system via the first signal line, receiving a sync clock signal from the timing control device via the second signal line and generating a plurality of driving signals to a display device of the display system according to the instruction signal and the sync clock signal.

2. The driving device of claim 1, wherein the plurality of driving units generates a feedback signal to the timing control device via the first signal line according to the instruction signal and the sync clock signal.

3. The driving device of claim 2, wherein the timing control device adjusts the instruction signal and the sync clock signal according to the feedback signal.

4. The driving device of claim 3, wherein the timing control device adjusts the instruction signal and the sync clock signal according to the feedback signal, to adjust operations of at least one of the plurality of driving units.

5. The driving device of claim 1, wherein the plurality of driving signals is used for controlling a plurality of scan lines of the display device.

6. The driving device of claim 1, wherein the plurality of driving signals is used for controlling a plurality of data lines of the display device.

7. The driving device of claim 1, wherein the plurality of driving signals comprises a plurality of first driving signals used for controlling a plurality of scan lines of the display device and a plurality of second driving signals used for controlling a plurality of scan lines of the display device.

8. The driving device of claim 1, wherein each of the plurality of driving units is coupled to the first signal line and the second signal line.

9. The driving device of claim 1, wherein a first driving unit of the plurality of driving units is coupled to the timing control device via the first signal line and the second signal line and is coupled to a second driving unit of the plurality of driving units via a third signal line and a fourth signal line for transmitting the instruction signal and the sync clock signal.

10. The driving device of claim 9, wherein a third driving unit of the plurality of driving units is coupled to a fourth driving unit of the plurality of driving units via a fifth signal line and a sixth signal line for receiving the instruction signal and the sync clock signal and is coupled to a fifth driving unit of the plurality of driving units via a seventh signal line and eighth signal line for transmitting the instruction signal and the sync clock signal.

11. The driving device of claim 1, wherein each of the plurality of driving units is coupled to the first signal line and a first driving unit of the plurality of driving units is coupled to the timing control device via the second signal line and is coupled to a second driving unit of the plurality of driving units via a third signal line for transmitting the sync clock signal.

12. The driving device of claim 11, wherein a third driving unit of the plurality of driving units is coupled to a fourth driving unit of the plurality of driving units via a fourth signal line for receiving the sync clock signal and is coupled to a fifth driving unit of the plurality of driving units via a fifth signal line for transmitting the sync clock signal.

13. A display system, comprising:
a display device;
a timing control device, for generating an instruction signal and a sync clock signal; and
a driving device, comprising:
a first signal line, connecting to the timing control device for transmitting the instruction signal;
a second signal line, connecting to the timing control device for transmitting the sync clock signal; and
a plurality of driving units, for receiving the instruction signal from a timing control device of the display system via the first signal line, receiving a sync clock signal from the timing control device via the second signal line and generating a plurality of driving signals to the display device according to the instruction signal and the sync clock signal.

14. The display system of claim 13, wherein the plurality of driving units generates a feedback signal to the timing control device via the first signal line according to the instruction signal and the sync clock signal.

15. The display system of claim 14, wherein the timing control device adjusts the instruction signal and the sync clock signal according to the feedback signal.

16. The display system of claim 15, wherein the timing control device adjusts the instruction signal and the sync clock signal according to the feedback signal, to adjust operations of at least one of the plurality of driving units.

17. The display system of claim 13, wherein the plurality of driving signals is used for controlling a plurality of scan lines of the display device.

18. The display system of claim 13, wherein the plurality of driving signals is used for controlling a plurality of data lines of the display device.

19. The display system of claim 13, wherein the plurality of driving signals comprises a plurality of first driving signals used for controlling a plurality of scan lines of the display device and a plurality of second driving signals used for controlling a plurality of scan lines of the display device.

20. The display system of claim 13, wherein each of the plurality of driving units is coupled to the first signal line and the second signal line.

21. The display system of claim 13, wherein a first driving unit of the plurality of driving units is coupled to the timing control device via the first signal line and the second signal line and is coupled to a second driving unit of the plurality of driving units via a third signal line and a fourth signal line for transmitting the instruction signal and the sync clock signal.

22. The display system of claim 21, wherein a third driving unit of the plurality of driving units is coupled to a fourth driving unit of the plurality of driving units via a fifth signal line and a sixth signal line for receiving the instruction signal and the sync clock signal and is coupled to a fifth driving unit of the plurality of driving units via a seventh signal line and eighth signal line for transmitting the instruction signal and the sync clock signal.

23. The display system of claim 13, wherein each of the plurality of driving units is coupled to the first signal line and a first driving unit of the plurality of driving units is coupled to the timing control device via the second signal line and is coupled to a second driving unit of the plurality of driving units via a third signal line for transmitting the sync clock signal.

24. The display system of claim 23, wherein a third driving unit of the plurality of driving units is coupled to a fourth driving unit of the plurality of driving units via a fourth signal line for receiving the sync clock signal and is coupled to a fifth driving unit of the plurality of driving units via a fifth signal line for transmitting the sync clock signal.
